(19) United States
(12) Patent Application Publication
(10) Pub. No.: US 2026/0093587 A1
(43) Pub. Date: Apr. 2, 2026

(54) OUT-OF-BAND POLICY ENFORCEMENT FOR DATA PROCESSING SYSTEMS USING ACTIVITY DATA

(71) Applicant: Dell Products L.P., Round Rock, TX (US)

(72) Inventors: ABEYE TESHOME, Austin, TX (US); RICHARD M. TONRY, Georgetown, TX (US); BASSEM EL-AZZAMI, Austin, TX (US); MOHIT ARORA, Frisco, TX (US); VINODKUMAR VASUDEV OTTAR, McKinney, TX (US); ADOLFO SANDOR MONTERO, Pflugerville, TX (US); LUIS ANTONIO VALENCIA REYES, Waxahachie, TX (US); RAJARAVI CHANDRA KOLLARAPU, Allen, TX (US)

(21) Appl. No.: 18/901,177

(22) Filed: Sep. 30, 2024

(51) Int. Cl. G06F 11/30; G06F 1/324; G06F 11/34

(52) U.S. Cl. CPC G06F 11/3048; G06F 1/324; G06F 11/3051; G06F 11/3452

(57) ABSTRACT

Methods and systems for managing operation of a data processing system are disclosed. Activity data for hardware resources of the data processing system may be obtained while the hardware resources are providing computer-implemented services to a user of the data processing system. The activity data may be analyzed to characterize use of the hardware resources by the user with respect to policies for the data processing system. The hardware resources may be adapted to independently enforce the policies when operating nominally; however, when the hardware resources are not operating nominally, a management controller of the data processing system may initiate performance of a policy enforcement process based on the characterized use of the hardware resources to modify provisioning of a portion of the computer-implemented services to the user.

### FIELD

Embodiments disclosed herein relate generally to managing data processing systems. More particularly, embodiments disclosed herein relate to systems and methods to enforce policies for the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a distributed system in accordance with an embodiment.

FIG. 1B shows a block diagram illustrating a data processing system in accordance with an embodiment.

FIG. 2 shows an interaction diagram in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may provide computer-implemented services to a user of the data processing system. To provide the computer-implemented services, hardware resources of the data processing system may function cooperatively with one another to perform various tasks. For example, processors, memory, and/or other hardware components of the hardware resources may participate in various processes in order to complete the tasks. The ability of the hardware resources to perform the tasks may be limited, for example, by maximum operational capacities of each of the hardware components, an availability of power (e.g., based on battery power capacity), and/or other constraints that may limit activity of the hardware resources.

For example, different processes may consume different quantities of processor capacity, memory capacity, and/or power in order to complete associated tasks. Therefore, in view of these limitations on the hardware resources, operation of the hardware resources may be managed (e.g., to optimize allocation of resources to various tasks) in order to increase a likelihood of providing desired computer-implemented services to the user.

To do so, when the hardware resources are operating nominally (e.g., in a desired state, as expected), activity data for the hardware resources may be collected over time as the hardware components perform various tasks (e.g., processes). The activity data may be monitored (e.g., analyzed) in order to manage allocation of portions of the hardware resources to ongoing and future tasks in accordance with policies for the data processing system. The activity data may include information regarding use of applications hosted by the hardware resources, processor usage, user-initiated activity, data transmission speed, fan speed, and/or other information usable to measure activity of the hardware and/or software components of the hardware resources.

For example, a software component of the hardware resources, such as a scheduler, may schedule tasks for performance by the hardware resources in accordance with scheduler policies for the data processing system. To do so, the scheduler may schedule tasks at various points in time based on analysis of historical and/or current activity of the hardware resources. In other words, the scheduler may perform load balancing (e.g., maintaining operational levels of the hardware components at or below their respective maximum operational capacities), to share resources (e.g., hardware components and/or power resources) effectively and in view of operational goals, and/or to achieve a target quality of computer-implemented services to the user.

However, when the hardware resources are not operating nominally (e.g., when the hardware resources are unable to operate in an expected manner, such as when the hardware resources are compromised and/or corrupted), then the hardware resources may be unable to reliably collect and analyze the activity data, and/or enforce policies corresponding to the (analysis of the) activity data. As a result, the hardware resources may not operate in compliance with the policies, which may prevent provisioning of the target quality of computer-implemented services to the user.

Thus, to improve a likelihood of providing the target quality of computer-implemented services to the user (e.g., when the hardware resources are unable to operate nominally), reliance on the hardware resources for policy enforcement may be reduced. To do so, the data processing system may include out-of-band components that may operate independently from in-band components (e.g., the hardware resources) of the data processing system.

The out-of-band components may include a management controller with functionality for managing operation of the in-band components. For example, the management controller may manage the collection and analysis of the activity data for the hardware resources, and may enforce policies based on the analysis of the activity data. During policy enforcement, operation of the hardware resources may be managed by the out-of-band components. For example, the management controller may modify process queues for the hardware resources, power consumption by the hardware resources, and/or perform other management functions in accordance with the policies.

By doing so, the policies may be more reliably enforced using out-of-band components than when using in-band components. When the policies are more likely to be reliably enforced, the computer-implemented services provided to the user may be more likely to meet the target quality of computer-implemented services.

In an embodiment, a method for managing operation of a data processing system is provided. The method may include: obtaining, in part by a management controller of the data processing system, activity data for hardware resources of the data processing system while the hardware resources are providing computer-implemented services to a user of the data processing system; analyzing, by the management controller, the activity data to characterize use of the hardware resources by the user with respect to policies for the data processing system, the hardware resources being adapted to independently enforce the policies while the hardware resources are operating nominally; and, initiating, by the management controller and using the hardware resources, performance of a policy enforcement process based on the characterized use of the hardware resources by the user to modify provisioning of a portion of the computer-implemented services to the user.

The method may further include identifying, by the management controller, whether the hardware resources are operating nominally, wherein the initiating of the performance of the policy enforcement process occurs when the hardware resources are not operating nominally.

The activity data may indicate a relative level of operation of a hardware component of the hardware resources with respect to a maximum operational capacity of the hardware component, and at least one of the policies may be keyed, at least in part, to the relative level of the operation of the hardware component.

Analyzing the activity data may include generating a derived quantity based on the activity data. Analyzing the activity data may include: obtaining a statistical characterization of the activity data, the statistical characterization being usable to characterize the use of the hardware resources by the user; and, obtaining an action for performance during the policy enforcement process based, at least, on the statistical characterization.

The performance of the policy enforcement process may include, in an instance of the analyzing of the activity data where the use of the hardware resources relates to power consumption: modifying, based on a corresponding policy of the policies, power consumption by the hardware resources to place the data processing system in a lower-powered state that complies with the corresponding policy. Modifying the power consumption may include at least one action selected from a list of actions comprising: reducing a clock rate; depowering a portion of a hardware component of the hardware resources; and, depowering the hardware component.

The performance of the policy enforcement process may include, in an instance of the analyzing of the activity data where the use of the hardware resources relates to user-initiated activity over time: modifying, based on a corresponding policy of the policies, performance of a background management process by the hardware resources to reduce an impact on the user-initiated activity. The modifying of the performance may include modifying a scheduled time for performance of the background management process to occur while the user-initiated activity over time is expected to be at reduced levels.

The data processing system may include a network module adapted to separately advertise network endpoints for the management controller and the hardware resources, the network endpoints being usable by a remote system to address communications to the hardware resources and the management controller.

An out-of-band communication channel that services the management controller may run through the network module, and an in-band communication channel that services the hardware resources may also run through the network module.

The management controller and the network module may be on separate power domains from the hardware resources so that the management controller and the network module are operable while the hardware resources are inoperable. The policies may be obtained by the management controller while the hardware resources are inoperable due to being unpowered.

A non-transitory media may include computer instructions that when executed by a processor cause the computer-implemented method to be performed.

The data processing system may include the non-transitory media and a processor, and may perform the computer-implemented method when the computer instructions are executed by the processor.

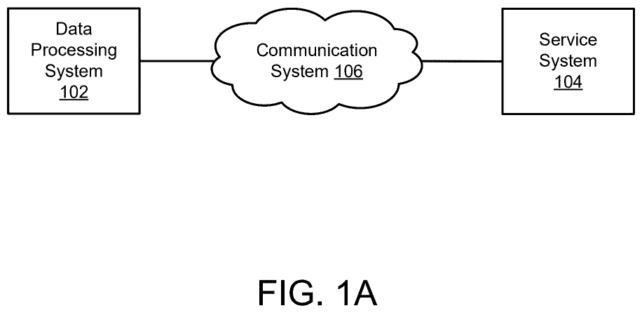

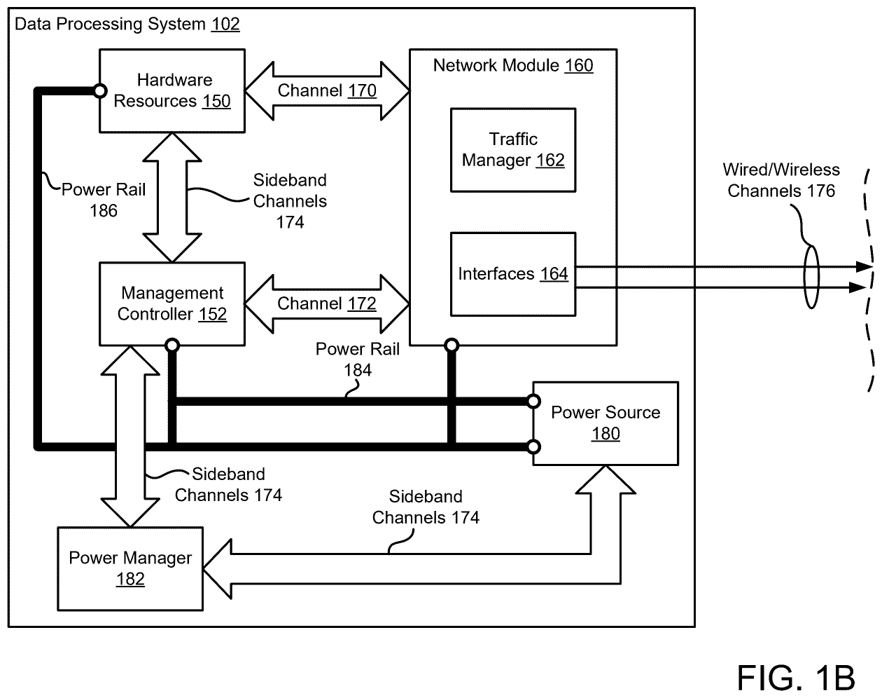

Turning to FIG. 1A, a block diagram illustrating a distributed system in accordance with an embodiment is shown. The system shown in FIG. 1A may provide computer-implemented services. The computer-implemented services may include any type and quantity of computer-implemented services. For example, the computer-implemented services may include communication services, data storage services, database services, data generation services, and/or any other type of service that may be implemented with a computing device.

To provide the computer-implemented services, the distributed system may include a data processing system (e.g., data processing system 102). The data processing system may include hardware and/or software components (e.g., hardware resources) and may provide computer-implemented services to a user of the data processing system.

The hardware resources that facilitate provisioning of the computer-implemented services may include hardware components such as processors, memory, network links, expansion cards, and power sources. To provide the computer-implemented services, the hardware resources may perform tasks (e.g., threads, processes, data flows), and the performance of the tasks may be limited by maximum operational capacities of the hardware resources (e.g., processing capacity, memory capacity, battery capacity).

Therefore, to provide a target quality of computer-implemented services in view of limited (e.g., constrained) hardware resources, policies for the data processing system may define allocation of hardware resources to various tasks (e.g., scheduler policies), and a quality of the computer-implemented services may depend on an ability of the data processing system to enforce the policies.

For example, the policies may be based on operational goals, such as workload balancing, maximizing throughput, minimizing wait time, minimizing response time (e.g., latency), maximizing fairness (e.g., resource allocation for multiple users) and/or other operational objectives (or combinations thereof) that may facilitate provisioning of the target quality of computer-implemented services. The policies may specify actions for managing operation (e.g., allocation) of the hardware resources based on historical and/or current activity of the hardware resources. Enforcement of the policies (e.g., performance of the actions) may increase a likelihood of providing the target quality computer-implemented services.

To enforce the policies, activity data for the hardware resources may be monitored (e.g., collected, analyzed) while the hardware resources are providing computer-implemented services to the user. The activity data may indicate a relative level of operation of a hardware components of the hardware resources with respect to a maximum operational capacity of the hardware component. Some of the policies may be keyed, at least in part, to relative levels of operation of the hardware resources. For example, a policy may be triggered by processor activity (e.g., usage) reaching a maximum threshold, available battery power falling below a minimum threshold, and/or by other circumstances during which the hardware resources may be unlikely to provide the target quality of computer-implemented services.

During enforcement of the triggered policy, the operation of the hardware resources may be modified in a manner that increases a likelihood of providing the target quality of computer-implemented services. For example, scheduler policies for the data processing system may specify that lower priority (e.g., background management processes) should be paused and/or not be performed as scheduled in order to re-allocate portions of the hardware resources to higher priority (e.g., user-initiated) processes.

The monitoring (e.g., collection, analysis) of the activity data and the enforcement of policies triggered by the activity data and/or results of an analysis of the activity data may be performed (e.g., independently) by the hardware resources while the hardware resources are operating nominally. However, if the hardware resources are not operating nominally (e.g., due to being compromised, corrupted, and/or otherwise incumbered to perform as expected), then the hardware resources may be unable to reliably collect and analyze the activity data, and/or identify policies for enforcement based on the activity data. As a result, a quality of the computer-implemented services may be reduced below the target quality.

In general, embodiments disclosed herein may provide methods, systems, and/or devices for managing operation of a data processing system in a manner that improves enforcement of policies that mitigate hardware resource constraints, even while the hardware resources are not operating nominally. To do so, the data processing system may include out-of-band components that operate independently from in-band components (e.g., the hardware resources) of the data processing system. The out-of-band components may be tasked with monitoring activity of the in-band components (e.g., obtaining and analyzing activity data for the data processing system), and initiating enforcement of policies based on the monitored activity data.

To do so, the out-of-band components may include functionality for managing tasks performed by the hardware resources. For example, the out-of-band components may perform actions to modify (e.g., reduce) power consumption by the hardware resources and/or that modify (e.g., reprioritize) performance of tasks (e.g., processes) by the hardware resources. As a result, provisioning of a portion of the computer-implemented services to the user may be modified in accordance with operational goals.

By doing so, appropriate policies relating to hardware resource allocation and/or management may be more likely to be enforced reliably and timely using the out-of-band components of the data processing system than when relying on the in-band components. Consequently, reductions in quality of computer-implemented services that may occur as a result of limited or constrained hardware resources may be more likely to be mitigated and/or prevented.

To provide the above-mentioned functionality, the distributed system of FIG. 1A may include data processing system 102, service system 104, and communication system 106. The distributed system, any components thereof, and/or any other types of devices or components not shown in FIG. 1A may perform all, or a portion of the computer-implemented services independently and/or cooperatively. Each of these components is discussed below.

Data processing system 102 may include any number of data processing systems. Data processing system 102 may be operated directly or indirectly (e.g., via other devices) by any number of users. Data processing system 102 may provide computer-implemented services to its user(s). For example, a user may operate data processing system 102 to obtain the computer-implemented services by initiating activity of the hardware resources (e.g., launching applications, providing input).

To provide the computer-implemented services, data processing system 102 may include in-band components such as hardware resources (e.g., hardware and/or software components). When the hardware resources are operating nominally, the hardware resources may be adapted to independently enforce policies such as scheduling policies for data processing system 102. For example, a software component (e.g., a scheduler) hosted by the hardware resources may schedule tasks for performance by the hardware resources in accordance with policies (e.g., scheduling policies) for the data processing system. The enforcement of the scheduling policies by the hardware resources may be triggered based on activity data for the hardware resources.

To manage policy enforcement (e.g., while the hardware resources are not operating nominally), data processing system 102 may include out-of-band components, such as a management controller. The management controller may include functionality for exchanging data with other devices (e.g., remote systems) via out-of-band communication channels. The management controller may operate independently from the hardware resources and may include functionality for managing (e.g., modifying) operation of the hardware resources when enforcing policies for data processing system 102. Refer to the discussion of FIG. 1B for more information regarding components of data processing system 102.

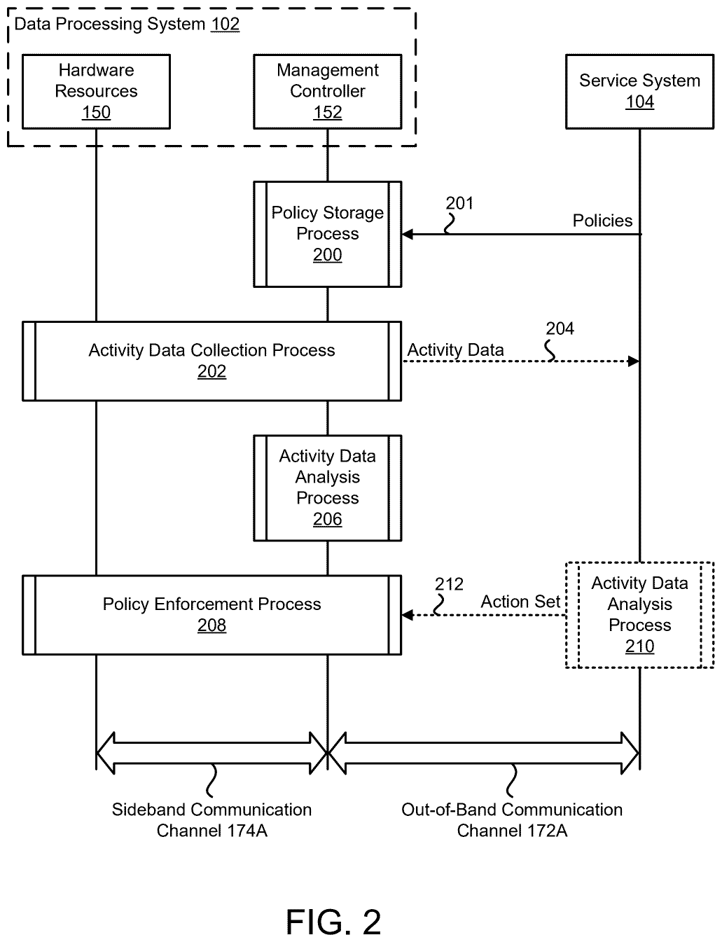

For example, to enforce the policies, the management controller may (i) obtain and/or store policies for data processing system 102 (e.g., from a remote system), (ii) obtain activity data for the hardware resources (e.g., while the hardware resources are providing computer-implemented services to a user of data processing system 102), (iii) analyze the activity data to characterize use of the hardware resources (e.g., by the user), (iv) identify policies that may be triggered based on the characterized use of the hardware resources, (v) initiate performance of policy enforcement processes to enforce triggered policies, and/or (vi) initiate other actions (e.g., modify provisioning of the computer-implemented services to the user). Refer to the discussion of FIG. 2 for more information regarding policy enforcement based on activity data.

Service system 104 may include any number of systems that provide computer-implemented (e.g., Cloud) services for data processing system 102. For example, service system 104 may include a system trusted by data processing system 102 to provide provisioning services, policy management services, data processing services, and/or other types of services for data processing system 102.

To perform the services, service system 104 may communicate and/or exchange data with components of data processing system 102. For example, when the hardware resources are operating nominally, service system 104 may provide its services using in-band methods (e.g., using hardware resources and in-band communication channels); otherwise, service system 104 may provide its services using out-of-band methods (e.g., using the management controller and out-of-band communication channels).

For example, service system 104 may (i) obtain new and/or updated policies for data processing system 102 (e.g., defined by an administrator of data processing system 102), (ii) provide the policies to data processing system 102 (e.g., during a provisioning process and/or when new or updated policies are available), (iii) obtain and/or analyze activity data for (hardware resources of) data processing system 102, (iv) provide actions to data processing system 102 (e.g., via the management controller) based on the analyzed activity data, and/or (v) perform other actions for managing policies and/or activity data for data processing system 102.

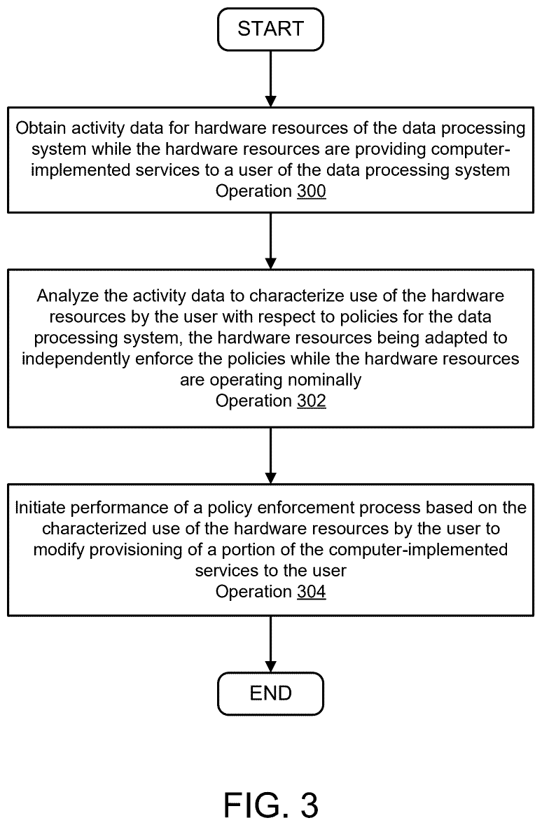

When providing their functionality, any of data processing system 102, service system 104, and/or components thereof may perform all, or a portion of the actions and methods illustrated in FIGS. 2-3.

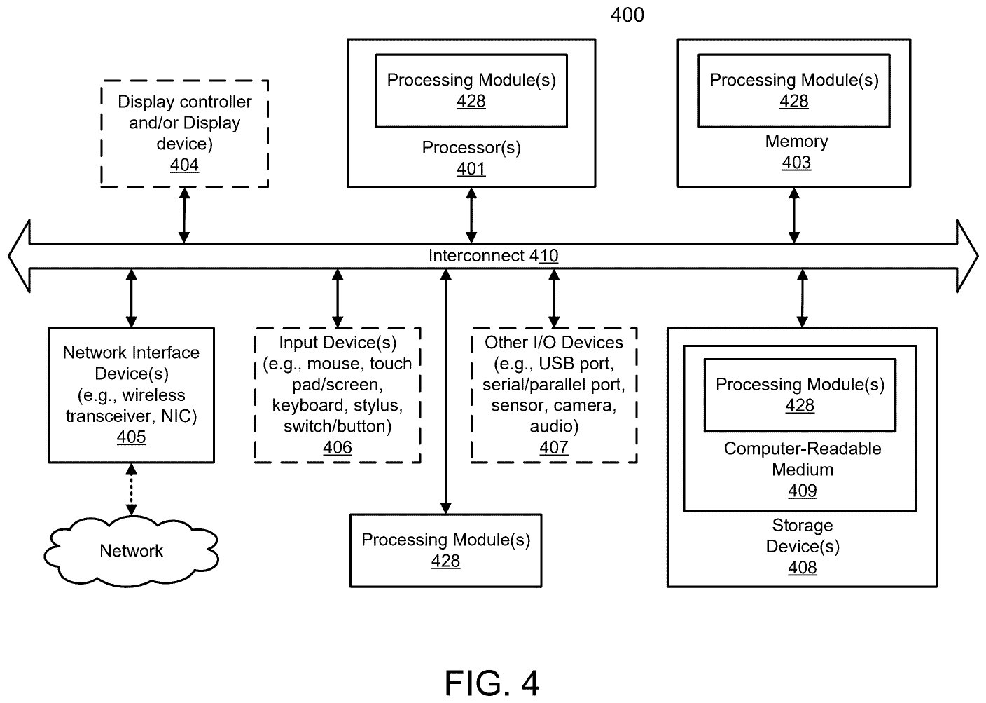

Any of data processing system 102 and service system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1A may be operably connected to each other (and/or components not illustrated) with communication system 106. Communication system 106 may facilitate communications between the components of FIG. 1A. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1A as including a limited number of specific components, a system in accordance with an embodiment may include fewer, additional, and/or different components than those illustrated therein.

Turning to FIG. 1B, a diagram illustrating a data processing system in accordance with an embodiment is shown. Data processing system 102 shown in FIG. 1B may be similar to any of the computing devices shown in FIG. 1A.

To provide computer-implemented services, data processing system 102 may include any quantity of hardware resources 150. Hardware resources 150 may be in-band (hardware) components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, then these entities may subsequently compromise the operation of the applications. For example, if various drivers and/or the communication stack are compromised, then communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 102) to another device via any number of intermediate networks (e.g., via wired/wireless channels 176 that are part of the networks).

To reduce the likelihood of the applications and/or other in-band entities from being indirectly compromised, data processing system 102 may include management controller 152 and network module 160. Each of these components of data processing system 102 is discussed below.

Management controller 152 may be implemented, for example, using a system on a chip or other type of independently operating computing device (e.g., independent from the in-band components, such as hardware resources 150 of a host data processing system 102). Management controller 152 may provide various management functionalities for data processing system 102. For example, management controller 152 may perform processes such as policy storage processes and/or activity data analysis processes independently (and/or surreptitiously) from hardware resources 150. Management controller 152 may, for example, monitor various ongoing processes performed by the in-band components, may manage power distribution, thermal management, and/or may perform other functions for managing data processing system 102. For example, management controller 152 may monitor activity of hardware resources 150 to verify that hardware resources 150 are enforcing policies as expected (refer to FIG. 2).

To do so, management controller 152 may be operably connected to various components via sideband channels 174 (in FIG. 1B, a limited number of sideband channels are included for illustrative purposes, it will be appreciated that management controller 152 may communicate with other components via any number of sideband channels such as sideband communication channel 174A shown in FIG. 2). The sideband channels may be implemented using separate physical channels, and/or with a logical channel overlay over existing physical channels (e.g., logical division of in-band channels).

The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, when managing enforcement of scheduling policies for data processing system 102, management controller 152 may use sideband channels 174 to initiate and/or perform, at least in part (e.g., in cooperation with hardware resources 150), activity data collection processes and/or policy enforcement processes.

To reduce the likelihood of indirect compromise of an application hosted by hardware resources 150, management controller 152 may, for example, enable information from other devices to be provided to the application without traversing the network stack and/or management entities of hardware resources 150. To do so, the other devices may direct communications including the information to management controller 152.

Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

For example, during a policy enforcement process, management controller 152 may provide instructions via sideband channels 174 to a software agent of management controller 152. The agent may act on (e.g., execute) the instructions in order to enforce policies for data processing system 102.

Management controller 152 may be operably connected to communication components of data processing system 102 via separate channels (e.g., 172, 172A shown in FIG. 2) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of any management controller 152, and entities hosted by management controller 152.

To facilitate communication with other devices, data processing system 102 may include network module 160. Network module 160 may provide communication services for in-band components and out-of-band components (e.g., management controller 152) of data processing system 102. To do so, network module 160 may include traffic manager 162, and interfaces 164.

Traffic manager 162 may include functionality to (i) discriminate traffic directed to various network endpoints advertised by data processing system 102, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

For example, when communicating with a remote system (e.g., service system 104), messages from the remote system may be addressed to a network endpoint advertised by network module 160 for out-of-band communications. The messages may include, for example, policies for data processing system 102 and/or other information. When messages are received by traffic manager 162, traffic manager 162 may forward the message to management controller 152 via an out-of-band communication channel (e.g., channel 172), differentiating the message from in-band communications to data processing system 102.

By doing so, data processing system 102 may be more likely to reliably and securely obtain the policies, even when hardware resources 150 are compromised, corrupted, and/or otherwise unable to operate nominally. Similarly, messages sent from management controller 152 (e.g., including activity data) to the remote system may be transmitted via the out-of-band communication channel to network module 160, bypassing potentially compromised and/or corrupted in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wireless wide area network (WWAN) card, a Wi-Fi card, a wireless local area network card, a wired local area network card, an optical communication card, and/or other types of communication components. These components may support any number of wired/wireless channels 176.

Thus, from the perspective of an external device, the in-band components and out-of-band components of data processing system 102 may appear to be two independent network entities that may be independently addressable and/or otherwise unrelated to one another.

To facilitate management of data processing system 102 over time, hardware resources 150, management controller 152 and/or network module 160 may be positioned in separately controllable power domains. By being positioned in these separate power domains, different subsets of these components may remain powered while other subsets are unpowered.

For example, management controller 152 and network module 160 may remain powered while hardware resources 150 are unpowered. Consequently, management controller 152 may remain able to communicate with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

Therefore, even when hardware resources 150 are not operating nominally (e.g., are unpowered), the out-of-band components may remain powered in order to perform actions relating to policy enforcement for data processing system 102. For example, while hardware resources 150 are unpowered, power distribution may be managed so that management controller 152 may still obtain policies for data processing system 102 from remote systems using out-of-band communication channels (e.g., channel 172).

By doing so, when the policies are updated (e.g., with service system 104), up-to-date policies may be provided to management controller 152 in real-time, increasing a likelihood that management controller 152 will have access to up-to-date policies for enforcement when hardware resources 150 become powered.

To implement the separate power domains, data processing system 102 may include a power source (e.g., 180) that separately supplies power to power rails (e.g., power rail 184, power rail 186) that power the respective power domains. Power from the power source (e.g., a power supply, battery, etc.) may be selectively provided to the separate power rails to selectively power the different power domains. A power manager (e.g., 182) may manage power from power source 180, supplied via the power rails (e.g., by providing instructions via sideband channels 174). Management controller 152 may cooperate with power manager 182 to manage supply of power to these power domains. Management controller 152 may communicate with power manager 182 via sideband channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

To further clarify embodiments disclosed herein, an interaction diagram in accordance with an embodiment is shown in FIG. 2. The interaction diagram may illustrate how data may be obtained and used within the system of FIGS. 1A-1B.

In the interaction diagrams, processes performed by and interactions between components of a (distributed) system in accordance with an embodiment are shown. In the diagrams, components of the system are illustrated using a first set of shapes (e.g., 150, 152, etc.), located towards the top of each figure. Lines descend from these shapes. Processes performed by the components of the system are illustrated using a second set of shapes (e.g., 200, 202) superimposed over these lines.

Interactions (e.g., communication, data transmissions, etc.) between the components of the system are illustrated using a third set of shapes (e.g., 201, 204) that extend between the lines. The third set of shapes may include lines terminating in arrows that may indicate one-way interactions (e.g., data transmission from a first component to a second component). Some of the third set of shapes may be drawn in dashing to indicate that corresponding interactions are optional and/or may not occur (e.g., 204, 212).

Thick arrows (e.g., sideband communication channel 174A, out-of-band communication channel 172A) may indicate communication channels over which multi-way interactions are facilitated (e.g., data transmission between two components).

Generally, the processes and interactions are temporally ordered in an example order, with time increasing from the top to the bottom of each page. For example, the interaction labeled as 201 may occur prior to the interaction labeled as 204. However, it will be appreciated that the processes and interactions may be performed in different orders, any may be omitted, and other processes or interactions may be performed without departing from embodiments disclosed herein.

Turning to FIG. 2, an interaction diagram in accordance with an embodiment is shown. The interaction diagram may illustrate processes and interactions that may occur when managing policy enforcement for a data processing system. The data processing system (e.g., data processing system 102) may be operated by a user and may include hardware resources 150, management controller 152, and/or other components (not shown). In the example shown in FIG. 2, hardware resources 150 may not be operating nominally. For example, hardware resources 150 may be compromised, corrupted, and/or otherwise unable to enforce policies of data processing system 102 as expected.

To manage policies for enforcement, management controller 152 may perform policy storage process 200. During policy storage process 200, management controller 152 may obtain policies for data processing system 102. For example, management controller 152 may obtain policies while participating in a provisioning process, and/or at other points in time over a lifecycle of data processing system 102 (e.g., when policies for data processing system 102 are updated and/or created). Data processing system 102 may obtain various types of services, including the provisioning services, from a trusted remote system such as service system 104.

As discussed with respect to FIG. 1A, service system 104 may perform policy management services for data processing system 102 and/or other devices. For example, policies stored by services system 104 may be managed by an administrator of a deployment that includes data processing system 102. Service system 104 may use a database to manage the policies, and the database may be queried by service system 104 in order to identify appropriate policies for data processing system 102 during provisioning and/or at the other points in time.

For example, the policies for data processing system 102 may be associated with information regarding management controller 152 such as unique identifiers for facilitating communication with management controller 152 (e.g., a medium access control (MAC) address), cryptographic information (e.g., shared secrets, certificates), and/or other information usable to securely provide policies to data processing system 102.

Service system 104 may provide the policies to data processing system 102 using in-band methods (e.g., via hardware resources 150 over in-band communication channels, not shown) and/or using out-of-band methods (e.g., via management controller 152 over out-of-band communication channel 172A). Service system 104 may provide the policies to data processing system 102 via one of or both methods, depending on an operational state of hardware resources 150. For example, when hardware resources 150 are not operating nominally, service system 104 may use out-of-band methods to provide the policies to data processing system 102.

To do so, management controller 152 may manage power distribution for portions of hardware resources 150 (e.g., power may be distributed to a network card and/or other components of data processing system 102) so that the policies may be obtained by management controller 152 while hardware resources 150 are inoperable due to being unpowered and/or while hardware resources 150 are corrupted and/or compromised. By doing so, the policies that are enforced may be more likely to be reliable (e.g., up to date, trustworthy) than when relying on in-band methods.

At interaction 201, service system 104 may provide the policies to management controller 152 over out-of-band communication channel 172A via (i) transmission via a message, (ii) storing in a storage with subsequent retrieval by management controller 152, (iii) a publish-subscribe system where management controller 152 subscribes to updates from service system 104 thereby causing a copy of the policies to be propagated to management controller 152, and/or (iv) other processes.

During policy storage process 200, management controller 152 may request policies from service system 104 (not shown) and/or service system 104 may automatically provide (e.g., push) the policies to management controller 152 without request. During policy storage process 200, management controller 152 may store the policies (e.g., in local storage and/or in storage of hardware resources 150) and/or manage enforcement of the policies.

The policies may include policies usable to manage scheduling of tasks for performance by hardware resources 150 (e.g., scheduling policies). For example, scheduling policies may specify (i) prioritization of tasks, (ii) guidelines for managing power consumption by hardware resources 150, and/or (iii) actions to be performed to achieve operational goals. The policies may be triggered based on historical and/or current activity of hardware resources 150.

For example, a first policy of the policies may be triggered by current and/or estimated processor utilization exceeding a maximum threshold, and a second policy of the policies may be triggered based on a current battery sourced power level being below a minimum threshold. Therefore, to identify policies for enforcement (e.g., triggered policies), the activity of hardware resources 150 may be measured.

To do so, management controller 152 may participate in activity data collection process 202. Activity data collection process 202 may be performed while hardware resources 150 are providing computer-implemented services to the user of data processing system 102. Activity data collection process 202 may be an ongoing process (e.g., a background process) performed by hardware resources 150 and/or management controller 152 cooperatively and/or independently while data processing system 102 is powered on and/or providing computer-implemented services to the user.

During activity data collection process 202, activity data for hardware resources 150 may be collected (e.g., obtained) by management controller 152 based on snooped activity of hardware resources 150 and/or data stored in hardware resources 150 (e.g., log data) via sideband communication channel 174A. For example, the activity data may include information regarding use of hardware resources 150 by applications, background processes, and/or user-initiated activity. The activity data may include information regarding data transmission speeds, disk read/write speeds, fan speeds, temperature measurements of hardware components of hardware resources 150, and/or any other information usable to measure activity of the hardware and/or software components of hardware resources 150 with respect to maximum operational capacities, speeds, temperatures, etc.

The activity data may indicate a relative level of operation of hardware components of hardware resources 150 with respect to a maximum operational capacity of the hardware component. For example, the activity data may include performance metrics such as network throughput, central processing unit (CPU) and/or graphics processing unit (GPU) utilization, and/or memory utilization. The performance metrics may include statistical characterizations of the activity of hardware resources 150 such as a percentage utilization relative to a maximum utilization capacity (e.g., CPU utilization per process), and may be used to characterize use of hardware resources 150 by the user (e.g., CPU utilization per user-initiated process and/or CPU utilization per background management process). The activity data may include timestamp information to facilitate characterizing use of hardware resources 150 over time.

To characterize the use of hardware resources 150, management controller 152 may perform activity data analysis process 206. During activity data analysis process 206, derived quantities based on the activity data may be generated. For example, management controller 152 may obtain statistical characterizations (e.g., ratio, mean, maximum, minimum) for portions of the activity data and/or may estimate use of hardware resources 150 over time (e.g., based on queued or anticipated processes and/or historical characterizations of use of hardware resources 150) to characterize the use of hardware resources 150. Use of hardware resources 150 may be characterized with respect to policies for data processing system 102.

Some of the policies of data processing system 102 may be keyed, at least in part, to relative levels of operation of the hardware components. For example, a scheduling policy of data processing system 102 may be triggered based on the characterized use of hardware resources 150, a time of day, a type of power source that is powering hardware resources 150, and/or other factors.

In a first example, during activity data analysis process 206, use of hardware resources 150 may be characterized with respect to power consumption by hardware resources 150. When hardware resources 150 are powered by a battery, a percentage of remaining battery (e.g., relative to a maximum capacity for the battery) may be obtained and compared to a threshold specified by a power consumption policy. If the percentage exceeds the threshold, then the policy may not be triggered. Otherwise, the policy may be triggered and actions to remediate a low availability of battery power may be obtained based on the power consumption policy.

In a second example, during activity data analysis process 206, use of hardware resources 150 may be characterized with respect to CPU utilization by user-initiated activity. For example, the user may be characterized as a power user during certain time periods (e.g., during certain hours of weekdays). Current and/or future estimated CPU utilization for user-initiated processes and/or applications relative to a maximum capacity of the CPU may be obtained and compared to a threshold specified by a task prioritization policy. If the current and/or future estimated CPU utilization exceeds the threshold (at any point in time including future points in time), then the policy may be triggered and time-dependent actions to manage (e.g., optimize) performance of CPU intensive processes may be obtained based on the task prioritization policy.

Activity data analysis process 206 may be performed concurrently with activity data collection process 202 so that activity data obtained by management controller 152 may be analyzed in real-time. A process similar to activity data analysis process 206 may be performed by service system 104 (e.g., activity data analysis process 210). For example, during activity data collection process 202, the collected activity data may be provided to service system 104 at interaction 204 over out-of-band communication channel 172A. Service system 104 may perform activity data analysis process 210 to characterize use of hardware resources 150 in addition to management controller 152 and/or instead of management controller 152 when management controller 152 is unable to do so (e.g., when resource-intensive analysis methods are required for analysis of the activity data). For example, results of the analysis of the activity data by service system 104 may be used to define new policies and/or update existing policies for data processing system 102.

Processes similar to activity data collection process 202 and/or activity data analysis process 206 may be performed by hardware resources 150 independently of management controller 152 (not shown). For example, when operating abnormally (e.g., not nominally), hardware resources 150 may attempt to enforce policies based on the activity data. However, management controller 152 may monitor enforcement of the policies by hardware resources 150 (e.g., by monitoring activity of hardware resources 150 via sideband communication channel 174A) to identify unexpected enforcement of the policies. For example, if management controller 152 identifies that hardware resources 150 are unable to enforce the policies as expected, then management controller 152 may identify that hardware resources 150 are not operating nominally. In response to non-nominal operation of hardware resources 150, management controller 152 may initiate performance of policy enforcement process 208.

During policy enforcement process 208, policies triggered by the activity data and/or results of activity data analysis process 206 may be enforced. To do so, management controller 152 may obtain actions corresponding to the triggered policies and initiate performance of the actions. For example, a statistical characterization of the activity data obtained during activity data analysis process 206 may trigger a scheduling policy for data processing system 102. The scheduling policy may be triggered based on a comparison of the statistical characterization with any number of thresholds specified by the scheduling policy. The scheduling policy may specify actions for remediating limited availability of portions of hardware resources 150 based on the comparison between the statistical characterization and the thresholds.

Consider the first example given above, where a power consumption policy is triggered based on a battery life percentage being inferior to a minimum threshold of the power consumption policy. The actions specified by the policy may include actions for modifying power consumption by hardware resources 150 in order to place data processing system 102 in a lower-powered state that complies with the power consumption policy. In the lower-powered state, power consumption of the hardware resources 150 may be reduced.

For example, the actions may include (i) reducing a clock rate (e.g., slowing processors, memory, and/or data transfer), (ii) de-powering a portion of a hardware component (e.g., de-powering at least one core of a multi-core processor), (iii) de-powering a hardware component (e.g., de-powering a GPU), and/or (iv) other actions that may reduce total power consumption by hardware resources 150 (e.g., dimming a screen of a display device powered by a power source of data processing system 102, restricting power-hungry and low priority applications).

Consider the second example given above, where a task prioritization policy is triggered based on CPU utilization exceeding a maximum threshold of the task prioritization policy. For example, the user of data processing system 102 may initiate activity (e.g., run applications or processes) that, in combination with background management processes, results in high CPU utilization. The high CPU utilization may negatively affect a quality of the computer-implemented services desired and/or expected by the user. Therefore, the actions specified by the task prioritization policy may include actions for modifying performance of a background management process by hardware resources 150 in order to reduce an impact on the user-initiated activity.

For example, the actions may include (i) pausing the background management process, (ii) modifying a scheduled time for performance of the background management process (e.g., to occur while the user-initiated activity is expected to be at reduced levels, outside of power user defined time periods), and/or (iii) other actions for deprioritizing performance of the background management process (and/or prioritizing performance of user-initiated processes). For example, the background management process may include anti-virus scans, data backup processes, hardware component maintenance processes, and/or other tasks of hardware resources 150 unrelated to the user-initiated activity that may be performed at other times without affecting a quality of the computer-implemented services expected by the user.

During policy enforcement process 208, actions for enforcing policies and/or otherwise mitigating limited availability of hardware resources 150 may be obtained from service system 104 (e.g., based on a result of activity data analysis process 210). For example, at interaction 212, service system 104 may provide the actions (e.g., an action set) to management controller 152 over out-of-band communication channel 172A using methods similar to those discussed with respect to interaction 201.

To initiate performance of the actions, management controller 152 may obtain, provide, and/or execute (portions of) instructions based on the actions (e.g., the triggered policies). By doing so, management controller 152 may manage operation of hardware resources 150 in order to enforce policies when hardware resources 150 are unable to independently enforce the policies. As a result of policy enforcement process 208, limited hardware resource availability may be remediated by modifying a portion of the computer-implemented services provided to the user.

Policy enforcement process 208 may be performed independently and/or cooperatively by management controller 152 and/or hardware resources 150. For example, portions of policy enforcement process 208 may be performed by an agent of management controller 152 hosted by hardware resources 150, by an operating system or other applications hosted by hardware resources 150 (e.g., using instructions provided by management controller 152 over sideband communication channel 174A), and/or by management controller 152 via sideband communication channel 174A.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using processes and interactions shown in FIG. 2, policies relating to activity of hardware resources of a data processing system may be enforced using out-of-band methods when the hardware resources are unable to enforce the policies as expected. By using a management controller of the data processing system to manage the policies, and obtain and analyze activity of the hardware resources, the policies may be more likely to be enforced as expected than when using in-band methods that rely on abnormally operating hardware resources.

Turning to FIG. 3, a flow diagram illustrating a method in accordance with an embodiment is shown. The flow diagram may illustrate various operations performed when enforcing policies for a data processing system using activity data.

At operation 300, activity data for hardware resources of the data processing system may be obtained while the hardware resources are providing computer-implemented services to a user of the data processing system. The activity data may be obtained by (i) receiving the activity data (e.g., from another device), (ii) reading the activity data (e.g., from storage), (iii) generating the activity data, and/or (iv) other methods (e.g., by using methods described with respect to activity data collection process 202 of FIG. 2). For example, a management controller of the data processing system may obtain the activity data by snooping activity of hardware resources 150 and/or obtaining data stored by hardware resources 150 over a sideband communication channel of the data processing system.

At operation 302, the activity data may be analyzed to characterize use of the hardware resources by the user with respect to policies for the data processing system. The activity data may be analyzed by generating a derived quantity based on the activity data. For example, the management controller may use statistical methods and/or other methods to predict (e.g., extrapolate) future activity data over time based on historical and/or present activity data. The derived quantity may include a current and/or predicted use of the hardware resources (e.g., by the user, by scheduled management processes) over time.

Analyzing the data may include (i) obtaining a statistical characterization of the activity data (e.g., usable to characterize use of the hardware resources by the user), and/or (ii) obtaining an action for performance during a policy enforcement process based, at least, on the statistical characterization. For example, the management controller may obtain the statistical characterization by (i) receiving the statistical characterization (e.g., from another device), (ii) reading the statistical characterization (e.g., from storage), (iii) generating the statistical characterization, and/or (iv) other methods (e.g., by using methods described with respect to activity data analysis process 206 of FIG. 2). The statistical characterization may be used, at least in part, to characterize use of the hardware resources.

At operation 304, performance of a policy enforcement process may be initiated based on the characterized use of the hardware resources by the user to modify provisioning of a portion of the computer-implemented services to the user. The hardware resources may be adapted to independently enforce the policies (e.g., analyze the activity data) while the hardware resources are operating nominally; however, when the hardware resources are not operating nominally, then the hardware resources may be unable to independently and/or reliably enforce the policies. The performance of the policy enforcement process may be initiated by identifying whether the hardware resources are operating nominally.

For example, the management controller may use the sideband communication channel to monitor (e.g., snoop) activity of hardware resources. The activity of the hardware resources may be compared to expected activity of the hardware resources to determine whether the hardware resources are operating nominally. For example, the hardware resources may not be collecting up-to-date activity data, analysis of the activity data may be delayed, and/or a result of the analysis of the activity data may be unexpected (e.g., the result of the analysis by the hardware resources may not match a result obtained by the management controller).

If the management controller identifies that the hardware resources are not operating nominally, then the management controller may initiate performance of the policy enforcement process. Otherwise, if the management controller identifies that the hardware resources are operating nominally (e.g., the analyzed activity data is up-to-date, and the result of the analysis matches the result obtained by the management controller), then the management controller may continue to monitor activity of the hardware resources, but may not initiate the policy enforcement process.

Initiating performance of the policy enforcement process may include (i) identifying a policy triggered by the activity data (e.g., the characterized use of the hardware resources), (ii) obtaining actions based on the policy, and/or (iii) initiating execution of instructions usable to perform the actions (e.g., using the hardware resources). For example, the management controller may initiate execution of the instructions by (i) executing a first portion of the instructions to manage operation of the hardware resources, and/or (ii) providing a second portion of the instructions to the hardware resources (e.g., via the sideband communication channel) for execution by the hardware resources.

In a first example where analysis of the activity data indicates that use of the hardware resources triggers a policy related to power consumption of the hardware resources, performing the policy enforcement process may include modifying (e.g., based on the triggered policy), power consumption by the hardware resources. The power consumption by the hardware resources may be modified by (i) reducing a clock rate, (ii) depowering a portion of a hardware component of the hardware resources, and/or (iii) depowering the hardware component.

For example, the management controller may obtain and execute instructions for modifying the clock rates of and/or depowering portions of the hardware resources. Executing the instructions (e.g., by the management controller and/or portions of the hardware resources, such as a power manager) may force a configuration on the hardware resources so that the data processing system is placed in a lower-powered state (e.g., lower than prior to modifying the power consumption) in compliance with the triggered policy.

In a second example where analysis of the activity data indicates that use of the hardware resources triggers a policy related to user-initiated activity over time, the policy enforcement process may include modifying performance of a background process by the hardware resources to reduce an impact on the user-initiated activity. The performance of the background management process may be modified by modifying a scheduled time for performance of the background management process.

For example, the management controller may modify the scheduled time for performance of the background management process by (i) pausing the background management process (e.g., to increase an availability of the hardware resources), (ii) re-prioritizing a task queue (e.g., processes in queue, including the background management process), (iii) initiating at least a portion of user-initiated processes (e.g., using newly available hardware resources), (iv) adjusting a schedule for background management processes so that the background management process occurs during a period of time while the user-initiated activity over time is expected (e.g., predicted, based on historical user-initiated activity) to be at reduced levels, and/or (v) other methods.

The method may end following operation 304.

Thus, as illustrated above, embodiments disclosed herein may provide systems and methods for managing operation of a data processing system in a manner that increases a likelihood of compliance with activity data related policies for the data processing system. By using out-of-band components such as a management controller of the data processing system to manage the activity data related policies and/or enforcement thereof, reliance on potentially compromised and/or corrupted hardware resources of the data processing system may be reduced.

Any of the components illustrated in FIGS. 1A-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for managing operation of a data processing system, the method comprising:
obtaining, in part by a management controller of the data processing system, activity data for hardware resources of the data processing system while the hardware resources are providing computer-implemented services to a user of the data processing system;
analyzing, by the management controller, the activity data to characterize use of the hardware resources by the user with respect to policies for the data processing system, the hardware resources being adapted to independently enforce the policies while the hardware resources are operating nominally; and
initiating, by the management controller and using the hardware resources, performance of a policy enforcement process based on the characterized use of the hardware resources by the user to modify provisioning of a portion of the computer-implemented services to the user, the performance of the policy enforcement process comprises modifying power consumption by the hardware resources to place the data processing system in a different powered state.

2. The method of claim 1, further comprising:
identifying, by the management controller, whether the hardware resources are operating nominally, wherein the initiating of the performance of the policy enforcement process occurs when the hardware resources are not operating nominally.

3. The method of claim 1, wherein the activity data indicates a relative level of operation of a hardware component of the hardware resources with respect to a maximum operational capacity of the hardware component, and at least one of the policies is keyed, at least in part, to the relative level of the operation of the hardware component.

4. The method of claim 1, wherein analyzing the activity data comprises generating a derived quantity based on the activity data.

5. The method of claim 1, wherein analyzing the activity data comprises:
obtaining a statistical characterization of the activity data, the statistical characterization being usable to characterize the use of the hardware resources by the user; and
obtaining an action for performance during the policy enforcement process based, at least, on the statistical characterization.

6. The method of claim 1, wherein the modifying of the power consumption by the hardware resources is performed as the policy enforcement process in an instance of the analyzing of the activity data where the use of the hardware resources relates to power consumption, and the different powered state is a lower-powered state of the data processing system that complies with a corresponding policy of the policies.

7. The method of claim 6, wherein the modifying of the power consumption comprises at least one action selected from a list of actions comprising:
reducing a clock rate;
depowering a portion of a hardware component of the hardware resources; and
depowering the hardware component.

8. The method of claim 1, wherein the performance of the policy enforcement process further comprises:
in an instance of the analyzing of the activity data where the use of the hardware resources relates to user-initiated activity over time:
modifying, based on a corresponding policy of the policies, performance of a background management process by the hardware resources to reduce an impact on the user-initiated activity.

9. The method of claim 8, wherein the modifying of the performance comprises modifying a scheduled time for performance of the background management process to occur while the user-initiated activity over time is expected to be at reduced levels.

10. The method of claim 1, wherein the data processing system comprises a network module adapted to separately advertise network endpoints for the management controller and the hardware resources, the network endpoints being usable by a remote system to address communications to the hardware resources and the management controller.

11. The method of claim 10, wherein an out-of-band communication channel that services the management controller runs through the network module, and an in-band communication channel that services the hardware resources also runs through the network module.

12. The method of claim 10, wherein the management controller and the network module are on separate power domains from the hardware resources so that the management controller and the network module are operable while the hardware resources are inoperable.

13. The method of claim 12, wherein the policies are obtained by the management controller while the hardware resources are inoperable due to being unpowered.

14. A non-transitory machine-readable medium having instructions stored therein, which when executed by a processor, cause the processor to perform operations for managing operation of a data processing system, the operations comprising:
obtaining, in part by a management controller of the data processing system, activity data for hardware resources of the data processing system while the hardware resources are providing computer-implemented services to a user of the data processing system;
analyzing, by the management controller, the activity data to characterize use of the hardware resources by the user with respect to policies for the data processing system, the hardware resources being adapted to independently enforce the policies while the hardware resources are operating nominally; and
initiating, by the management controller and using the hardware resources, performance of a policy enforcement process based on the characterized use of the hardware resources by the user to modify provisioning of a portion of the computer-implemented services to the user, the performance of the policy enforcement process comprises modifying power consumption by the hardware resources to place the data processing system in a different powered state.

15. The non-transitory machine-readable medium of claim 14, wherein the operations further comprising:
identifying, by the management controller, whether the hardware resources are operating nominally, wherein the initiating of the performance of the policy enforcement process occurs when the hardware resources are not operating nominally.

16. The non-transitory machine-readable medium of claim 14, wherein the activity data indicates a relative level of operation of a hardware component of the hardware resources with respect to a maximum operational capacity of the hardware component, and at least one of the policies is keyed, at least in part, to the relative level of the operation of the hardware component.

17. The non-transitory machine-readable medium of claim 14, wherein analyzing the activity data comprises generating a derived quantity based on the activity data.

18. A data processing system, comprising:
a processor; and
a memory coupled to the processor to store instructions, which when executed by the processor, cause operations to be performed, the operations comprising:
obtaining, in part by a management controller of the data processing system, activity data for hardware resources of the data processing system while the hardware resources are providing computer-implemented services to a user of the data processing system;
analyzing, by the management controller, the activity data to characterize use of the hardware resources by the user with respect to policies for the data processing system, the hardware resources being adapted to independently enforce the policies while the hardware resources are operating nominally; and
initiating, by the management controller and using the hardware resources, performance of a policy enforcement process based on the characterized use of the hardware resources by the user to modify provisioning of a portion of the computer-implemented services to the user, the performance of the policy enforcement process comprises modifying power consumption by the hardware resources to place the data processing system in a different powered state.

19. The data processing system of claim 18, wherein the operations further comprise:
identifying, by the management controller, whether the hardware resources are operating nominally, wherein the initiating of the performance of the policy enforcement process occurs when the hardware resources are not operating nominally.

20. The data processing system of claim 18, wherein the activity data indicates a relative level of operation of a hardware component of the hardware resources with respect to a maximum operational capacity of the hardware component, and at least one of the policies is keyed, at least in part, to the relative level of the operation of the hardware component.
